(19) United States
(12) Patent Application Publication
(10) Pub. No.: US 2007/0188610 A1
(43) Pub. Date: Aug. 16, 2007

(54) SYNOPTIC BROAD-AREA REMOTE-SENSING VIA MULTIPLE TELESCOPES

(75) Inventors: Michael V. Micotto, Saint Louis, MO (US); Lawrence L. Dambra, Boca Raton, FL (US)

Correspondence Address: BROSEMER, KOLEFAS & ASSOCIATES, LLC - (BOEING), 1 BETHANY ROAD, HAZLET, NJ, 07730, US

(73) Assignee: THE BOEING COMPANY, Chicago, IL (US)

(21) Appl. No.: 11/307,555

(22) Filed: Feb. 13, 2006

(51) Int. Cl. H04N 7/18

(52) U.S. Cl. 348/144

(57) ABSTRACT

A synoptic, broad-area remote-sensing system using multiple sensors mounted on an airborne platform. Commercially available optical telescopes can be used as the sensors and can be mounted to the platform with fixed location and orientation to collectively view a wide strip of land. Each telescope views a generally linear coverage area which overlaps an adjacent coverage area of another telescope. The images from the coverage areas of the multiple telescopes are stitched in electronic image processing into continuous strips of high-acuity image data. Calibration, distortion correction, alignment and the like are carried out in the electronic image processing using proven, commercially available hardware and software. The image detection for each telescope can be implemented using a linear arrangement of multiple, overlapping linear detectors to yield a wide, high-acuity, virtual field-of-view. The linear detectors can be commercially available detectors with multi-spectral capabilities. A system with large-area synoptic coverage can thus be implemented using low cost, commodity optics and detectors in combination with commercially available image processing hardware and software.

### FIELD OF THE INVENTION

The present invention relates to remote sensing, particularly to synoptic broad-area remote-sensing, such as may be performed using an airborne platform.

### BACKGROUND INFORMATION

Today, remote sensing resources are constrained. In general, it is necessary to have a-priori knowledge of what is to be observed in order to observe it, and discovery is often problematic unless one knows where to look. Conventional overhead remote sensing systems have limited, predictable areas of coverage, whereas conventional high altitude airborne remote sensing systems are typically capable of obtaining only small areas of high acuity sensor data within a reasonable amount of time. Currently used airborne remote sensors are generally expensive stabilized sight systems that cover very limited swath widths. Building up a composite sensor picture for an entire area of interest (e.g., a small country) currently takes place over an objectionably long period of time, during which parts of the picture become obsolete due to temporal changes.

Recent technology advances in two-dimensional (2D) focal planes have lead to large 2D array mosaics that partly satisfy some synoptic sensing objectives. While the mosaic 2D approach may provide area coverage with high acuity, it does so only in one spectral band and over a limited area.

Another approach has been to deploy multiple telescopes flying on multiple platforms acquiring imagery at varying times. While providing wider areas of coverage, such an approach suffers many of the same limitations as other non-synoptic approaches discussed above.

There has been a long-felt need for a new remote sensing paradigm in which a synoptic, broad area remote sensing capacity, with persistent access, allows large volumes of multi-spectral data to be captured in a single pass over vast extents of physical territory. Such a paradigm would enable maximizing the remote sensing “take” to allow comprehensive coverage of a broad area with a base sensor source for a given point in time.

### SUMMARY OF THE INVENTION

In an exemplary embodiment, the present invention provides a sensing system capable of both large area coverage and high acuity multi-spectral sensing in a single pass. An exemplary embodiment of a system in accordance with the present invention includes multiple optical telescope assemblies, preferably mounted with fixed location and orientation to an airborne platform. Each telescope assembly includes a linear multi-spectral time delay integrated (TDI) detector array. Image processing stitches the images captured by each telescope assembly, with alignment compensation, to thereby effectively create one large virtual array. The resultant product can be stored and/or disseminated to remotely located users.

In an exemplary embodiment for high altitude observing platforms, the resultant sweep width can be 100 nautical miles or more. Depending on platform speed (e.g., 100 Knots to hypersonic), a system in accordance with the present invention can provide synoptic coverage of small and medium countries in tens of minutes to hours, and could provide the basis for change detection over wide urban areas with fast revisit rates.

Systems in accordance with the present invention also preferably have an architecture that is amenable to scaling-up in accordance with the number of detector arrays per focal plane, the number of spectral bands that are detected, and the number of telescopes. Furthermore, a system can be implemented in accordance with the present invention using off-the-shelf components to perform real-time image processing for subsonic as well as hypersonic speed platforms, which would produce higher data rates.

The present invention satisfies a long-felt need for a remote sensing system with a synoptic, broad area remote sensing capability, with persistent access, allowing large volumes of multi-spectral data to be captured in a single pass over vast extents of physical territory.

The present invention provides a base sensor source that can serve multiple purposes, including, for example: providing a metric base source for commercial and non-commercial remote sensing; providing multi-spectral inputs to automatic cueing and discovery algorithms to focus subsequent sensing activities; providing a large map comparison source to detect changes as subsequent sensing data is acquired; providing a synoptic “still” source to allow identification of discrete entities, eliminating miscues such as double counting and miss-association that are common when the map is formed over a long time; and providing an initial map of all activity in a wide area so that a cue arriving at a later time can be paired with pre-existing conditions, thereby enabling derivation of a time history of events.

The aforementioned and additional features and advantages of the present invention will be apparent from the following description and attached drawings.

### BRIEF DESCRIPTION OF THE DRAWINGS

FIG. 1 is a block diagram illustrating generally the operation of an exemplary synoptic remote sensing system in accordance with the present invention.

FIG. 2 is a schematic representation of an arrangement of airborne telescopes in an exemplary synoptic remote sensing system of the present invention.

FIG. 3 is a cross-sectional view of an exemplary telescope for use in a system in accordance with the present invention.

FIG. 4 shows an exemplary arrangement of detectors for a telescope in a system in accordance with the present invention.

FIG. 5 is a schematic illustration of a parallel image processing architecture for use in an exemplary embodiment of a system in accordance with the present invention.

FIG. 6 is a block diagram illustrating an exemplary processing flow of image data in a system in accordance with the present invention.

### DETAILED DESCRIPTION

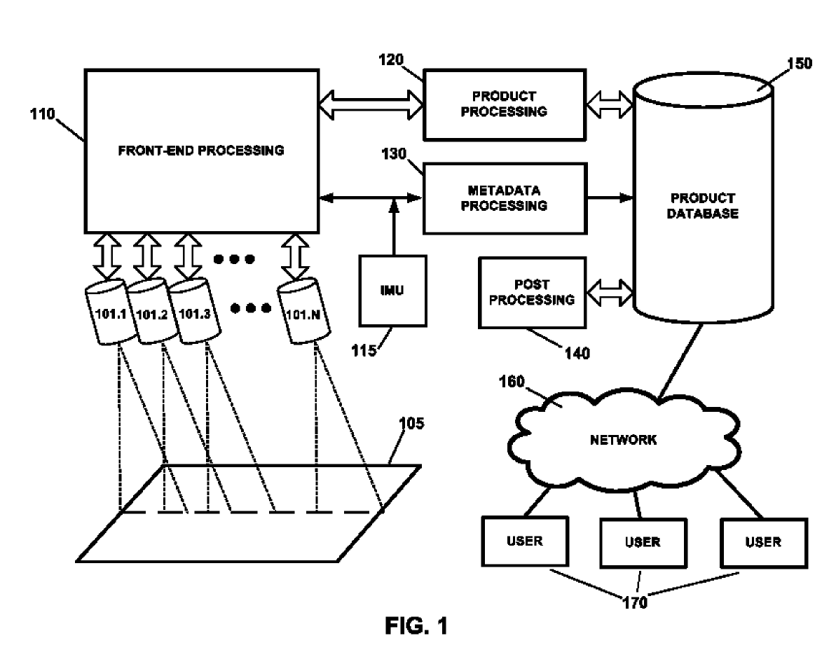

FIG. 1 is a block diagram illustrating the operation of an exemplary synoptic remote sensing system in accordance with the present invention. The system depicted in FIG. 1 includes a plurality of optical telescopes 101.1-101.N, each of which includes an array of one or more high-resolution detectors. As described in greater detail below, the telescopes 101 capture images, preferably multi-spectral, of adjacent patches of ground over-flown by an airborne platform onto which the telescopes are mounted. (The term “airborne” as used herein is not meant to be limited to aircraft but is intended to also refer to spacecraft or any other vehicle capable of deployment above the earth's surface.)

The detectors of the telescopes 101 are coupled to a front-end processing block 110 which performs real-time, electronics processing, such as time delay integration (TDI), calibration, data formatting, transfer and storage, and higher-level functions such as array-to-array registration and alignment. An exemplary implementation of the front-end block 110 which makes extensive use of parallel circuitry and processing is described below.

From the telescope detector signals, the front-end processing block 110 generates and provides multiple, individual strips of high acuity, multi-spectral data. This data can then be further processed by a product processing block 120, either in the air or on the ground, to stitch together a continuous, geo-referenced composite mosaic image. The product processing block 120 may carry out image processing algorithms to compensate for strip overlap, skew, and non-linearity due to perspective differences.

A metadata processing block 130 may process metadata that is generated in conjunction with the image data. Such metadata may include any data indicative of the conditions in which the sensing system operates, i.e., the sensing environment, and may include, for example, the time and place of the sensing, environmental conditions (e.g., weather, temperature), and sensor settings (e.g., sensor viewing angle). Such metadata can be provided by instrumentation on the platform, including, for example, an Inertial Measurement Unit (IMU) 115.

A post processing block 140 may perform any of a variety of algorithmic processes that operate on the sensor data set, after collection, that improve the data set, and may include, for example, error correction, reformatting, enhancement, and extraction of features.

The processing blocks 120-140 can be implemented using one or more general purpose computers running industry standard software. For example, photogrammetric production software is available from The Boeing Company and others. Metadata processing software and product archive and product holdings index/retrieval software packages are also offered by multiple vendors.

The end-product processed image can be stored in a product database 150 which may be made remotely accessible to multiple users 170 via a data communications network 160 (e.g., local or wide area).

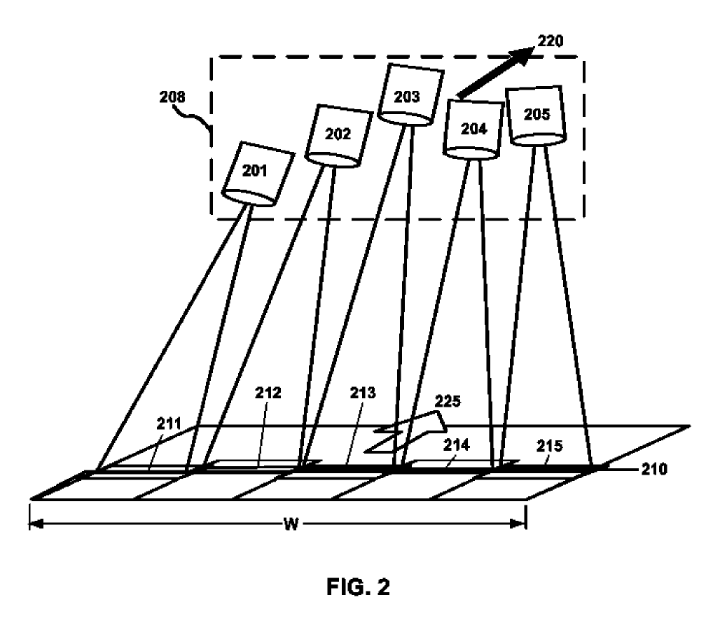

FIG. 2 is a schematic representation of an arrangement of telescopes 201-205 on an airborne platform 208 (e.g., air vehicle, not shown) in an exemplary embodiment of a synoptic remote sensing system in accordance with the present invention. The telescopes 201-205 focus on adjacent ground patches 211-215 arranged along a scan line 210 which is preferably generally perpendicular to the direction of motion 220 of the platform. There is some overlap between adjacent ground patches 211-215. In an exemplary embodiment, the scan width W across the patches 211-215 is approximately 100 Nm, with a platform altitude of 70,000 feet. Scan widths in the range of 30 to 120 Nm over a wide range of platform altitudes (e.g., 30,000 to 100,000 or more feet) are contemplated by the present invention.

The telescopes 201-205 can be mounted with only rough pointing alignment. As mentioned above, each telescope is pointed so that its coverage area 211-215 overlaps slightly with an adjacent coverage area of another telescope. This yields a gapless virtual field-of-view (FOV) when the images captured by the telescopes are combined.

Relative to the platform, the telescopes 201-205 are preferably fixed in location and orientation (i.e., “staring”) and can be installed at various locations on the platform. By fixedly referencing the telescopes to the platform, a significant expense typically associated with precision stabilized sights is avoided. Rather than rely on costly, high-accuracy pointing mechanics for the sensor, the present invention takes advantage of proven post processing software to stitch together a unified, referenced image product.

The sweep rate (i.e., the speed at which the scan line 210 moves along the ground in the direction of the arrow 225) corresponds to the ground speed of the platform. Platform speeds ranging from subsonic to hypersonic are contemplated by the present invention.

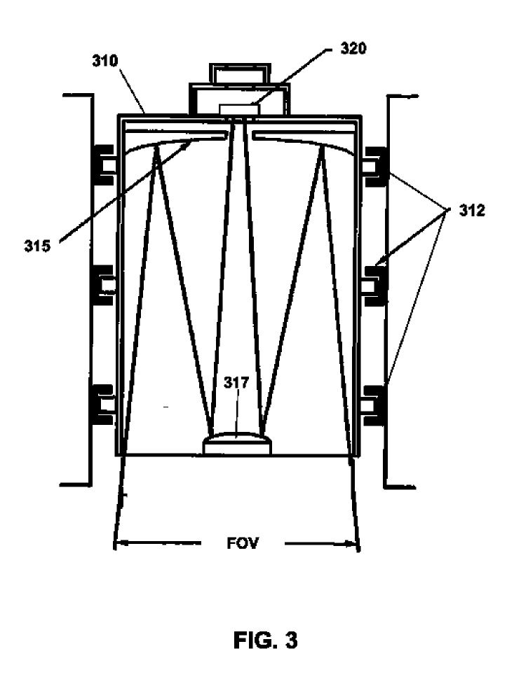

Each telescope 201-205 can be implemented, for example, as shown in FIG. 3. As shown in the cross-sectional view of FIG. 3, each telescope comprises an optical assembly 310, which is preferably float mounted to the platform on dampened vibration isolation mounts 312. Preferably, only low frequency telescope motion would need to be compensated for electronically in the image processing.

Each optical assembly 310 includes a primary mirror 315 and a secondary mirror 317, arranged as shown in FIG. 3. A detector array 320 is arranged at the focal point of the optical assembly.

The telescopes can be implemented using, for example, commercially available Ritchey-Chrétien or Cassegrain telescopes with 8″ to 24″ apertures and F numbers (F/#) in the 10 to 15 range. Each telescope has a linear field-of-view (FOV) preferably between 4 and 15 degrees. Telescopes with the smaller FOVs are preferably used off-nadir to compensate for longer slant range.

Using off-the-shelf linear detector array technology, an exemplary embodiment of a system with ten to twelve telescopes provides an image resolution with a ground sample distance (GSD) of approximately 1 to 2 feet from nadir to 70 degrees (i.e., +/−20 degrees on either side of nadir), with a 60 Nm wide scan width. For the sake of cost economies, the telescopes may all have the same optical assembly 310 configured with different secondary mirrors to attain different resolutions as the look angle moves away from Nadir. Although ten to twelve telescopes are used in this exemplary embodiment, more or less could be used depending on off-nadir performance requirements.

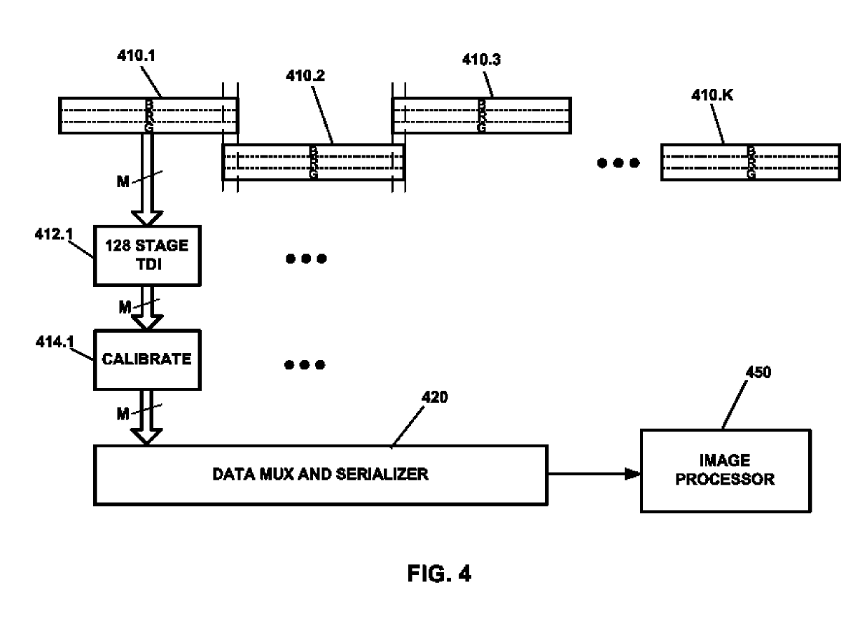

FIG. 4 provides a schematic illustration of an arrangement of linear detector arrays for use in an exemplary embodiment of a system in accordance with the present invention.

State-of-the-art detector arrays currently can provide up to 10,000 linear pixel elements in a multi-spectral time delay integrated (TDI) package compatible with the optical assembly sizes and focal numbers discussed above. To obtain data in the infrared (IR) spectrum, the arrays may use a cryo-cooler. Additionally, a simple folding mirror could be arranged near the detectors to switch between separate visual and infrared detectors. If IR performance is not needed, however, multi-color detector arrays could be used, simplifying the detector arrangement and reducing cost and complexity. The arrangement of FIG. 4 includes multiple multi-spectral, visual linear array detectors 410.1-410.K, each with M×1 pixels for each spectral band (e.g., color). The detectors can be commercial COTS charge-coupled devices (CCD), for example.

The detectors 410 shown in FIG. 4 are staggered and arranged with overlap to synthesize a substantially larger virtual array at the focal plane of an individual telescope, such as that shown in FIG. 3. The degree of overlap between adjacent detectors 410 should preferably be small in proportion to the total array size, yet large enough to ensure that there are a sufficient number of pixels between adjacent detectors so that no data is lost. It is also preferable that there are no redundant pixels, if possible. In an exemplary embodiment using detectors of M=1,024 pixels, with an overlap of 50 pixels between adjacent detectors, a telescope having K=10 detectors would, in effect, have a 10,000-pixel virtual detector array. All of the telescopes 101 may have the same sized virtual detector arrays or virtual detector arrays of different sizes depending, for example, on their viewing angle relative to nadir. The different sizes of virtual detector arrays can be achieved by varying the size (M) of each detector 410 or the number (K) of detectors.

The electrical signals produced by the detectors 410 are read out for each spectral band (e.g., the colors blue, red and green) via time delay shift registers 412, averaged, then forwarded at the image-generation clock rate to a calibration circuit 414. In the exemplary embodiment shown, 128 elements of time-delay-integration (TDI) are provided for each of the colors to achieve good SNR. The TDI 412 and calibration signal processing 414 can be integrated into the detector 410.

The outputs of the calibration blocks 414 for the detectors 410.1-410.K are provided to a data multiplexer and serializer block 420. For each spectral band (blue, red, green), the system includes a corresponding block 420 which generates a serial bit stream of image data at a rate of approximately 68 MBytes/sec. Each data multiplexer and serializer block 420 outputs its image data stream to a corresponding image processor 450, described below in greater detail.

The block diagram of FIG. 4 is replicated for each spectral band (e.g., color: red, green and blue, or IR) that is captured by the linear detector array of each telescope.

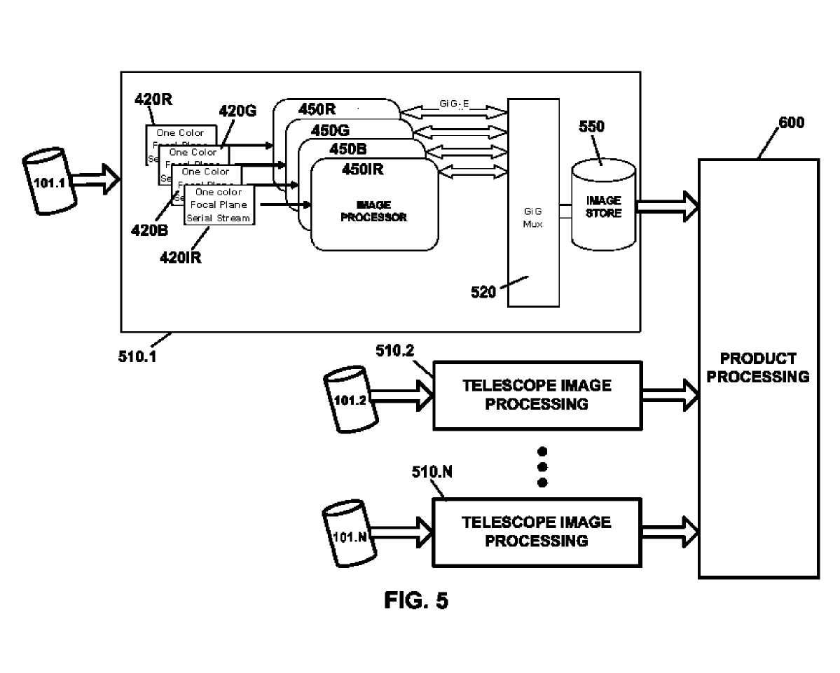

FIG. 5 is a schematic illustration of a parallel image processing architecture for use in an exemplary embodiment of a system in accordance with the present invention. The exemplary system includes a telescope image processing block 510 for each telescope 101. Each processing block 510.1-510.N processes the spectral information (e.g., red, green, blue, IR) captured by its corresponding telescope 101.1-101.N.

As shown in FIG. 5, the data stream for each color (R, G, B) and IR is output by its respective data mux and serializer block 420 (designated 420R, 420G, 420B and 420IR) and provided to an image processor 450R, 450G, 450B and 450IR, respectively. Each image processor 450 forms a calibrated and compressed image for each spectral band from its respective data stream.

Each image processor 450 can be implemented, for example, with a dedicated single board computer (SBC), such as a Power PC or equivalent.

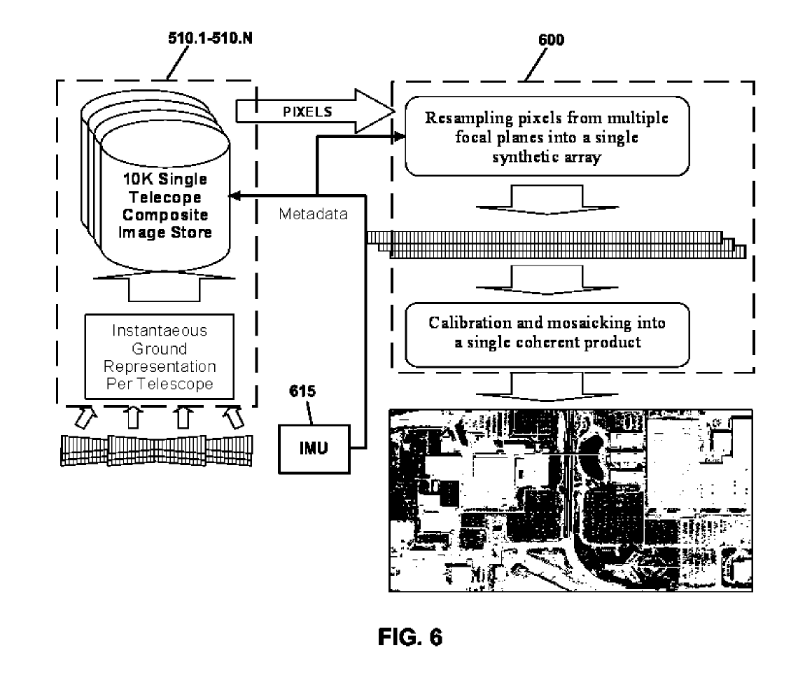

Image data from each image processor 450 is sent over a high speed network (e.g., GigaEthernet), and multiplexed 520 for archiving in a high speed image store 550. The image store 550 of each processor block 510.1-510.N thus contains a series of multi-color, 10K pixel wide images of variable length captured by its respective telescope 101.1-101.N. The images from the various telescopes are ready to be accessed, aligned, and mosaiced together by a further, product processing block 600 whose operation is illustrated in FIG. 6. (The product processing block 600 corresponds to the product processing block 120, discussed above in connection with FIG. 1, whereas the processor blocks 510.1-510.N, collectively, correspond to the front-end processing block 110.)

The product processing block 600 forms a contiguous mosaic from the images provided by the processor blocks 510.1-510.N. The product processing block 600 also receives metadata such as from an IMU 615.

Each telescope has an instantaneous field of view that has geometric distortion which must be corrected to feed an accurate product generation process. A general form of the eight-parameter equations for oblique distortion is as follows:

$${X}^{′} \approx \frac{ax + by + c}{fx + gy + 1}$$

$$and$$

$${Y}^{′} \approx \frac{dx + ey + f}{fx + gy + 1}$$

The product processing block 600 may also perform calibration processing in order to match the image data from the multiple telescopes on the platform. Such matching may be necessitated due to variations, for example, in the atmospheric conditions through which radiation captured by each telescope travels, in the illumination of the areas imaged by each telescope, and in the performance of individual telescopes and their detectors. Such variations may further vary with time.

The general equation for calibration, including atmospheric correction optical MTF compensation and a tonal transfer curve adjustment, also referred to as tonality matching is as follows:

$${Pixel}^{′} \approx Pixel \times Gain \times [ \begin{matrix}[ \begin{matrix}{Atm}_{11} & {Atm}_{12} & {Atm}_{13} \\ {Atm}_{21} & {Atm}_{22} & {Atm}_{23} \\ {Atm}_{31} & {Atm}_{32} & {Atm}_{33}\end{matrix} ] \\ [ \begin{matrix} {MTF}_{11} & {MTF}_{12} & {MTF}_{13} \\ {MTF}_{21} & {MTF}_{22} & {MTF}_{23} \\ {MTF}_{31} & {MTF}_{32} & {MTF}_{33}\end{matrix} ] [ \begin{matrix} {Tone}_{1} \\ {Tone}_{2} \\ {Tone}_{3}\end{matrix} ]\end{matrix} ] - Offset$$

The product processing block 600 may also perform geo-rectification to account for perspective changes and slight misalignments in the sensors.

The aforementioned processes can be performed, in-part, by a wide variety of commercial, photogrammetric production software systems. The product processing block 600 can be implemented as a general purpose computer programmed to execute such software. Examples of such software include: SOFTPLOTTER, from The Boeing Company, IMAGESTATION from ZI Imaging, and GEOMATICA from PCI Geomatics. These packages include functionality to: set up photogrammetric math models for specific sensors and geometries; rectify (adjust the geometric perspective of an imagery source to remove acquisition distortion); orthorectify (rectify and remove distortions cause by terrain); calibrate (adjust the radiometric characteristics and tonality of multiple image sources); and mosaic (assemble multiple imagery sources into a single coherent product).

It is understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1. An overhead remote sensing system comprising:
a plurality of telescopes, each telescope including an optical assembly and a detector, wherein the detector generates signals representative of an image of a coverage area in a field of view of the optical assembly, the coverage area of each telescope overlapping the coverage area of at least one other telescope; and
an image processor, wherein the image processor combines the images of the coverage areas into a combined image of a combined coverage area, the combined coverage area including the coverage areas,
wherein the telescopes are mounted to an airborne platform.

2. The system of claim 1, wherein the telescopes are mounted to the airborne platform with substantially fixed positions and orientations.

3. The system of claim 1, wherein the detector includes multiple sub-detectors.

4. The system of claim 3, wherein the multiple sub-detectors are linear detectors and are arranged linearly with overlap between adjacent sub-detectors.

5. The system of claim 3, wherein the sub-detectors detect emissions of at least two spectral bands.

6. The system of claim 5, wherein the emissions include visible light and infrared.

7. The system of claim 1, wherein the image processor includes a telescope image processor for each telescope.

8. The system of claim 7, wherein the detectors detect emissions of at least two spectral bands and each telescope image processor includes a sub-processor for each spectral band.

9. The system of claim 8, wherein each sub-processor includes a single-board computer.

10. The system of claim 8, wherein each sub-processor can process image data provided at a rate of approximately 68 Mbytes/sec.

11. The system of claim 7, wherein each telescope image processor includes an image store.

12. The system of claim 1, wherein the plurality of telescopes includes ten telescopes.

13. The system of claim 1, wherein the combined coverage area has a width of approximately 30 to 120 nautical miles.

14. The system of claim 1, wherein the combined coverage area is imaged with a ground sample distance of at most two feet.

15. The system of claim 1, wherein the detector has a resolution of approximately 10,000 pixels.

16. The system of claim 1, wherein the plurality of telescopes includes a Cassegrain telescope.

17. The system of claim 1, wherein each of the plurality of telescopes has an F number of approximately 10 to 15.

18. The system of claim 1, wherein the coverage areas of the plurality of telescopes are arranged along a line.

19. The system of claim 1, wherein each of the plurality of telescopes has a field-of-view of approximately 4 to 15 degrees.

20. The system of claim 1, wherein a first of the plurality of telescopes having a first field-of-view points in a first direction and a second of the plurality of telescopes having a second field-of-view points in a second direction, the first direction being closer to nadir than the second direction and the first field-of-view being wider than the second field-of-view.

21. A method of overhead remote sensing comprising:
providing a plurality of telescopes, each telescope including an optical assembly and a detector, wherein the detector generates signals representative of an image of a coverage area in a field of view of the optical assembly, the coverage area of each telescope overlapping the coverage area of at least one other telescope;
combining the images of the coverage areas into a combined image of a combined coverage area, the combined coverage area including the coverage areas; and
providing an airborne platform, wherein the telescopes are mounted to the airborne platform.
